(19) United States
(12) Patent Application Publication
(10) Pub. No.: US 2017/0117733 A1
(43) Pub. Date: Apr. 27, 2017

(54) POWER COORDINATION AMONG PORTABLE DEVICES WITH MULTIPLE POWER SOURCES

(71) Applicant: SAFETY INNOVATIONS INTERNATIONAL, LLC, Logan, UT (US)

(72) Inventors: Erich J. Pletsch, Highland, UT (US); David J. Havell, Salt Lake City, UT (US); Alex Ferro, Salt Lake City, UT (US)

(21) Appl. No.: 15/196,361

(22) Filed: Jun. 29, 2016

Related U.S. Application Data
(60) Provisional application No. 62/245,929, filed on Oct. 23, 2015.
(60) Provisional application No. 62/245,197, filed on Oct. 22, 2015.

(51) Int. Cl. H02J 7/00; G06F 1/16

(52) U.S. Cl. CPC H02J 7/0063; G06F 1/163; H04B 1/385

(57) ABSTRACT

A power management system includes a plurality of inputs that may be coupled to a plurality of devices to receive power therefrom and a plurality of outputs that may be coupled to the plurality of devices to provide power thereto. A device may include a load and an internal power sources that may be used to power the load or may be coupled by the power management system to another device. Likewise, the load may receive power from another device. The power management system couples each input to one of the outputs. An output is selected for an input based on priorities associated with the outputs and inputs. Each input and output may be coupled to a power bus by a multiplexer such that each input may be coupled to any output by coupling both to a common bus line.

### RELATED APPLICATIONS

This application claims the benefit of U.S. Provisional Patent Application Ser. No. 62/245,197, filed Oct. 22, 2015 and U.S. Provisional Patent Application Ser. No. 62/245,929, filed Oct. 23, 2015. Both of the foregoing references are hereby incorporated herein by reference.

### BACKGROUND

1. Field of the Invention

This invention relates to power supplies for portable devices and, more particularly, to novel systems and methods for sharing power among portable devices.

2. Background Art

A modern law enforcement officer or soldier relies on many electronic devices on a daily basis. For example, a police officer may have a radio, a body-worn camera, a cell phone, a laptop computer, or other devices. Many of these devices may be mounted to the officer's clothing. It is critical that these devices receive power in many situations.

The systems and methods disclosed herein provide an improved approach for providing power to portable electronic devices.

### BRIEF SUMMARY OF THE INVENTION

In view of the foregoing, in accordance with the invention as embodied and broadly described herein, a method and apparatus are disclosed in one embodiment of the present invention.

In one aspect of the invention a system includes a plurality of devices collectively including plurality of loads and a plurality of sources at least a portion of the plurality of devices including both of one of the loads of the plurality of loads and one of the sources of the plurality of sources, each source of the plurality of sources storing electrical power and each load of the plurality of loads being an electronic device that consumes electrical power. A controller is coupled to the plurality of devices and is programmed to:
assign a priority to each load of the plurality of loads;
assign a priority to each source of the plurality of sources according to a current state of the each source; and
couple the plurality of loads to the plurality of sources such that each load of the plurality of loads is coupled to a selected source of the plurality of sources, the selected source being selected according to the priority of the each load and the priority of the selected source, wherein each load of the plurality of loads is coupled to a different source of the plurality of sources.

In some embodiments, each device of the plurality of devices includes a separate housing, the housing including a mounting structure for mounting to the clothing of a person. The plurality of devices may include two or more of a radio, a body-worn camera, a laptop computer, flashlight and a cellphone. The plurality of devices may further include a portable power generator.

In some embodiments, the system further includes a power bus including a plurality of lines. A plurality of multiplexers are each coupled to one of (a) one of the plurality of loads and (b) one of the plurality of sources. Each multiplexer of the plurality of multiplexers has a control input thereof coupled to the controller and is further coupled to the plurality of lines of the bus. The controller may be further programmed to couple each load to the selected source thereof by causing the multiplexers of the plurality of multiplexers coupled to the each load and the selected source to select a same line of the plurality of lines.

In some embodiments, the controller is further programmed to: (a) monitor usage of each source of the plurality of sources; (b) adjust the priority of each source of the plurality of sources according to the usage; and (c) couple at least one load of the plurality of loads from the selected source thereof and coupling the at least one load to a new source of the plurality of sources in response to adjusting of the priority of each source of the plurality of sources.

In some embodiments, the controller is programmed to adjust the priority of each source of the plurality of sources according to the usage by reducing the priority of the each source in response to a reduction in charge remaining in the each source. The controller may be programmed to reduce the priority of each source of the plurality of sources in response to detecting a rise in temperature of the each source. The controller may be programmed to reduce the priority of each source of the plurality of sources in response to detecting a temporary loss of power from the each source.

In some embodiments, the controller is further programmed select the selected source according to the priority of the each load and the priority of the selected source by ordering the plurality of sources according to priorities thereof and assigning to the each load an available source from the plurality of sources that has a highest priority of all available sources of the plurality of sources.

A method corresponding to the system is also disclosed and claimed herein.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic block diagram of a power management system coupled to a plurality of portable devices in accordance with an embodiment of the present invention;

FIG. 2 is a schematic block diagram of a power coordinating and control device in accordance with an embodiment of the present invention;

FIG. 3 is a schematic block diagram illustrating details of devices coupled to the power coordinating and control device in accordance with an embodiment of the present invention;

FIG. 4 is a process flow diagram of a method for starting up a control device in accordance with an embodiment of the present invention;

FIG. 5 is a process flow diagram of a method for initializing ports in accordance with an embodiment of the present invention;

FIG. 6 is a process flow diagram of an input initialization process in accordance with an embodiment of the present invention;

FIG. 7 is a process flow diagram of an output initialization process in accordance with an embodiment of the present invention;

FIG. 8 is a process flow diagram of a method for handling connections to ports in accordance with an embodiment of the present invention;

FIG. 9 is a process flow diagram of a method for discovering a connected device in accordance with an embodiment of the present invention;

FIG. 10 is a process flow diagram of a method for validating an input in accordance with an embodiment of the present invention;

FIG. 11 is a process flow diagram of a method for handling disconnection of a device in accordance with an embodiment of the present invention;

FIG. 12 is a process flow diagram of a method for initializing monitoring in accordance with an embodiment of the present invention;

FIG. 13 is a process flow diagram of a method for monitoring a port in accordance with an embodiment of the present invention;

FIG. 14 is a process flow diagram of a method for selecting an input in accordance with an embodiment of the present invention;

FIG. 15 is a process flow diagram of a method for connecting an output to an input in accordance with an embodiment of the present invention;

FIG. 16 is a process flow diagram of a method for finding an available input in accordance with an embodiment of the present invention;

FIG. 17 is a process flow diagram of a method for prioritizing inputs in accordance with an embodiment of the present invention;

FIG. 18 is a process flow diagram of a method for automatically determining input priority in accordance with an embodiment of the present invention;

FIG. 19 is a process flow diagram of a method for initializing power management in accordance with an embodiment of the present invention; and

FIG. 20 is a process flow diagram of a method for managing power in accordance with an embodiment of the present invention.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

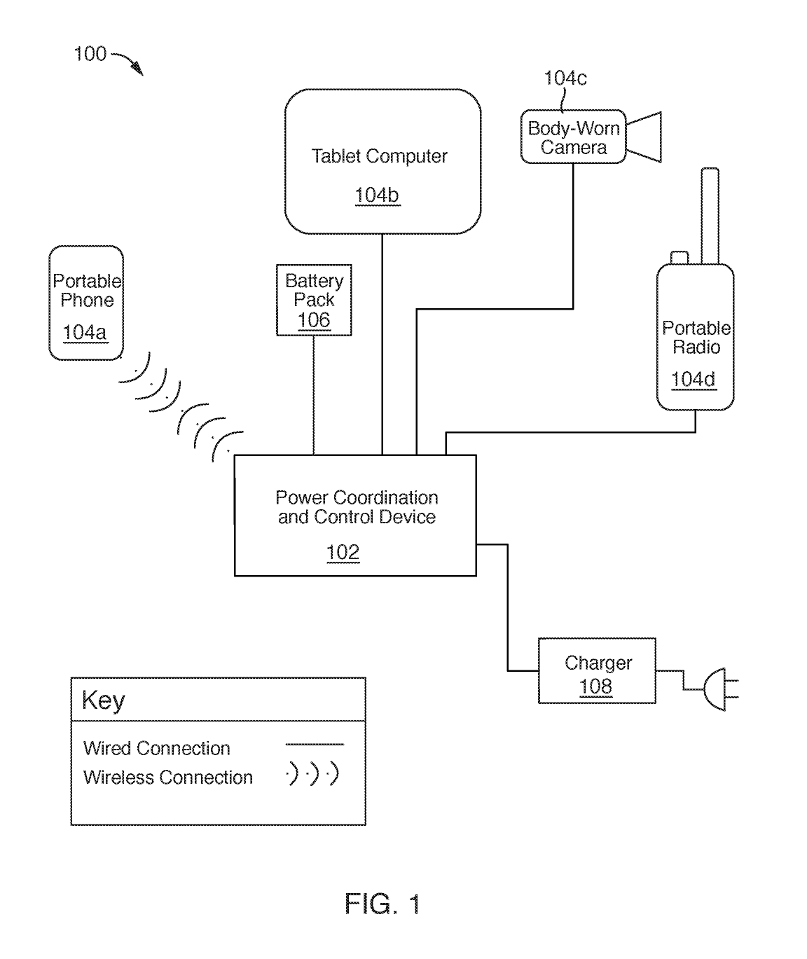

Referring to FIG. 1, a system 100 may include a power coordination and control device 102 (herein after control device 102). The control device 102 is coupled to one or more electronic devices such as a portable phone 104a, tablet computer 104b, body-worn camera 104c, portable radio 104d, or other electronic devices. Two or more of the devices 104a-104d include a source of electrical power such as a battery. At least one of the devices consumes electrical power. Any of the devices 104a-104d may function as both a load and a source of electrical power. Some or all of the devices 104a-104d are separate devices having separate housings and separately mountable to a wearer's clothing, such as to a utility belt or elsewhere. Other types of devices may include by example but not limitation a headset, tablet computer, smart watch, wearable computer, flashlight, or portable media player. In some embodiments, one or more of the devices 104a-104d function exclusively as a load, such as any one of the above-listed devices that does not include an internal battery.

The system 100 may further include devices that function exclusively as power sources, such as a battery pack 106 or a charger 108. The battery back 106 may be a rechargeable battery pack. The charger 108 may be configured to receive power from a wall socket (e.g. 110V) or from a DC voltage source, such as a car battery. Other examples of power sources that may be part of the system 100 include a transformer for coupling to a power source (e.g., wall socket) or a wireless (e.g., inductive) charging system.

Power sources coupled to the control device 102 may include power generating devices such as solar panels, kinetic generators, fuel cells, or a biological source of electrical power. A power source may store power in the form of a charge capacitor, battery, compressed air, thermal energy, or any other source of energy that may be converted into electrical power.

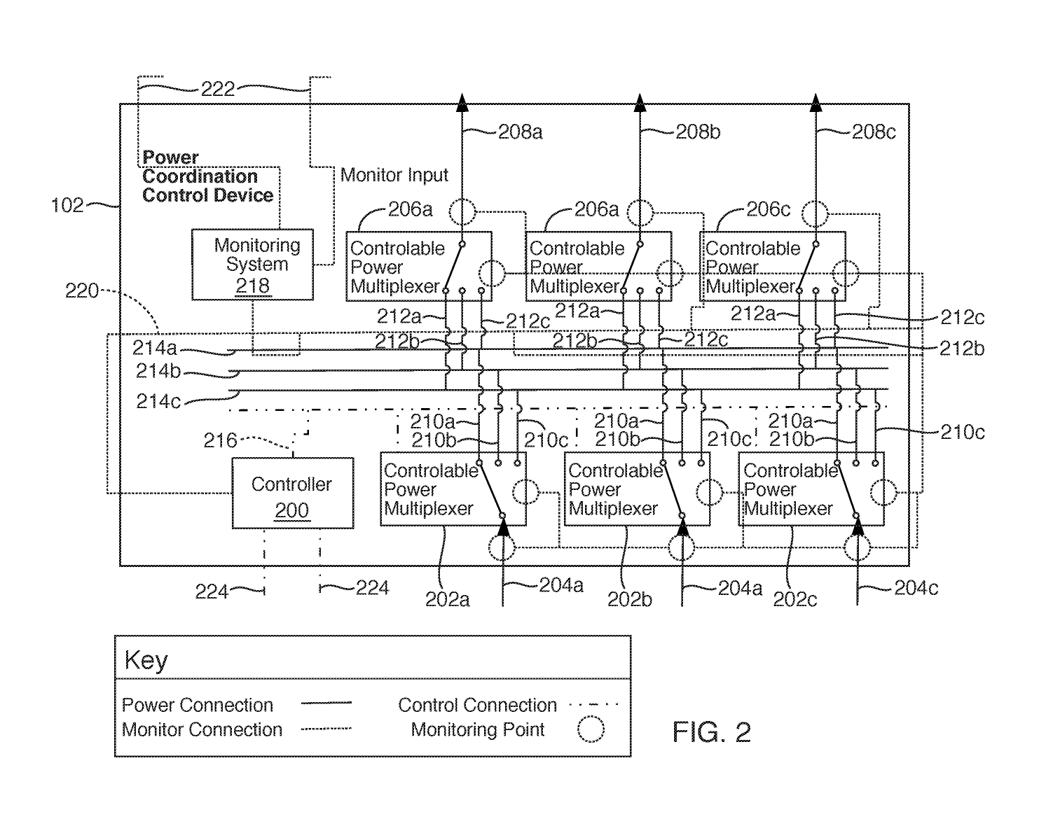

Referring to FIG. 2, the power coordination and control device 102 may include a controller 200 that includes a programmed or programmable device that executes the methods described hereinbelow. The controller 200 may be embodied as a hardwired device (e.g. application specific integrated circuit (ASIC)), programmable device (field programmable gate array (FPGA)), or general purpose computer. Where embodied as a computer, the controller 200 may include one or more processing devices (e.g. central processing units (CPU)), one or more memory devices coupled to the one or more processing devices (e.g. RAM), and one or more persistent storage devices coupled to the one or more processing devices (e.g. hard disk drive or flash drive). The one or more memory devices may store executable code effective to cause the one or more processing devices to execute the methods described herein.

The controller 200 may be coupled to a plurality of multiplexers (MUX), such as a plurality of input MUXs 202a-202c each having an input line 204a-204c. The controller 200 may further be coupled to output MUXs 206a-206c each coupled to an output line 208a-208c.

Each MUX 202a-202c may have a plurality of output lines 210a-210c selectively coupled by the MUX 202a-202c to the input line 204a-204c in accordance with a control signal. Likewise each MUX 206a-206c may include a plurality of input lines 210a-210c selectively coupled by the MUX 206a-206c to the output line 208a-208c thereof in accordance with a control signal. The output lines 210a-210c are each coupled to one bus line 214a-214c of a bus. The input lines 212a-212c are likewise each coupled to one of the bus lines 214a-214c. Accordingly, any one of the input lines 204a-204c may be coupled to any one of the output lines 208a-208c by coupling the corresponding MUXs 202a-202c, 206a-206c to the same bus line 214a-214c. For example, input line 204a may be coupled to output line 208c, by applying a control signal to MUX 202a to couple input line 204a to output line 210a and applying a control signal to MUX 206c to couple output line 208c to input line 212a, thereby coupling both MUXs 202a, 206c to bus line 214a.

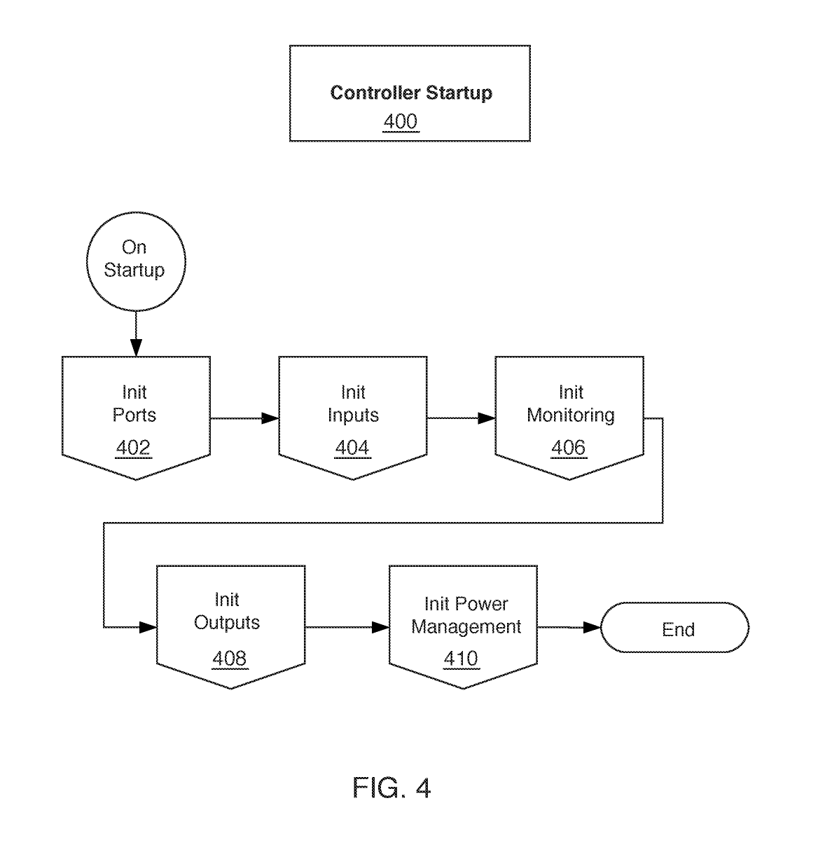

The MUXs 202a-202c, 206a-206c may include circuits effective to avoid drops in voltage or current during switching thereof. In particular, the MUXs 202a-202c, 206a-206c may include one or more reactive components configured as known in the art to avoid voltage and or current drops exceeding some acceptable threshold during switching. Likewise, the controller 200 may be programmed to ensure that switching is performed smoothly without interrupting power to loads coupled to the output lines 208a-208c. The controller 200 may be coupled to a control bus 216 coupled to the selection inputs of the MUXs 202a-202c, 206a-206c. The manner in which the control bus 216 controls the MUXs 202a-202c, 206a-206c in order to manage the provision of power from a plurality of sources to a plurality of loads to a plurality of loads is described below with respect to FIGS. 4-18. In some embodiments, the controller 200 may be configured to receive manual inputs instructing coupling of a load to a source and cause the MUXs 202a-202c, 206a-206c to couple the load to the source in response to the manual inputs.

The power coordination and control device 102 may include a monitoring system 218 coupled to a monitoring bus 220 having lines coupled to some or all of the MUXs 202a-202c, 206a-206c, the input lines 204a-204c, the output lines 208a-208c, and the controller. The monitoring system 218 may inherently or based on its programming monitor some or all of current levels, voltage levels, consumed power (e.g. Coulombs or Watt-hours), fluctuations in power usage by a device, or other values. The monitoring system 218 may monitor a state of the MUXs 202a-202c, 206a-206c (e.g. a currently selected line).

The monitoring system 218 may be embodied as a hardwired device (e.g. application specific integrated circuit (ASIC)), programmable device (field programmable gate array (FPGA)), or general purpose computer. Where embodied as a computer, the monitoring system 218 may include one or more processing devices (e.g. central processing units (CPU)), one or more memory devices coupled to the one or more processing devices (e.g. RAM), and one or more persistent storage devices coupled to the one or more processing devices (e.g. hard disk drive or flash drive). The one or more memory devices may store executable code effective to cause the one or more processing devices to execute the functions ascribed herein to the monitoring system 218 and other monitoring functions described below with respect to FIGS. 4-18.

The monitoring system 218 may record monitored values. For example, the monitoring system 218 may store a usage profile for loads and derive values such as average current drawn, maximum current drawn, and like information. Such information may then be used by the controller 200 to select a source having sufficient capacity to power the load.

In some embodiments, the controller 200 and monitoring system 218 may perform their above-described functions with respect to components external to the power coordinating and control device 102. Accordingly, the monitoring system 218 may include monitoring inputs 222 that are coupled to an external device and the controller 202 may provide control signal outputs 224 that are coupled to an external device.

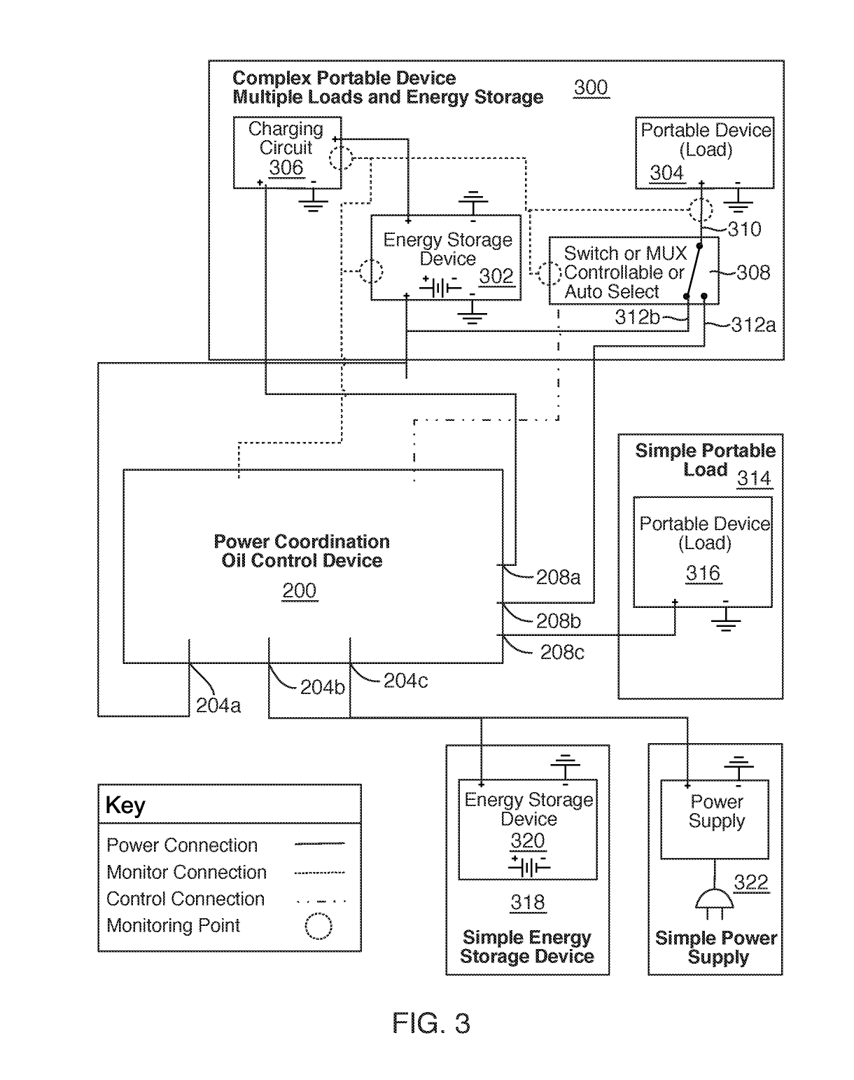

Referring to FIG. 3, the control device 102 may be coupled to devices having various configurations and capabilities. For example, one or more the monitor inputs 222 and one or more of the control outputs 224 may be coupled to a complex portable device 300 having multiple loads and energy storage. For example, device 300 may include an energy storage device 302 (e.g. rechargeable battery), a load device 304 (e.g. a video camera, radio, taser, etc.), and a charging circuit 306 (e.g. an adapter for receiving power from a vehicle battery, wall outlet, or adapter coupled to a vehicle battery or wall outlet).

The device 300 may include a MUX 308 having an output coupled to the portable load 30 and a plurality of inputs 312a-312b each coupled to one of the energy storage device 302 and one of the outputs 208a-208c of the control device 102. The MUX 308 may be coupled to one of the control outputs 224 such that in response to signals on the control output 224, the MUX 308 changes its state to coupled a different input 312a-312b to the output 310. In this manner, the controller 200 may control a source of power to the portable load 304. In the illustrated embodiment, the charging circuit 306 is also coupled to one of the outputs 208a-208c of the control device 102.

One or more of the monitoring inputs 222 of the control device 102 may be coupled to some or all of the energy storage device 302, portable load 304, charging circuit 306, and MUX 308 and receive signals therefrom indicating the state of these components. In the illustrated embodiment, the energy storage device 302 is also coupled to one of the input lines 204a-204c of the control device 102 such that the energy storage device 302 may be used to power a different device through one of the output lines 208a-208c of the control device 102.

The control device 102 may be coupled to a simple portable device 314 that includes a portable device load 316 but lacks an energy storage device. Accordingly, the load 316 is simply coupled to one of the outputs 208a-208c of the control device 102.

The control device 102 may be coupled to a simple energy source 318 that includes an energy storage device 320 (e.g. battery) but no load device. Accordingly, the energy source 318 may be coupled exclusively to one of the inputs 204a-204c of the control device 102. A power supply 322 may likewise simply be coupled to one of the inputs 204a-204c in order to provide a potential source of power to any one of the outputs 208a-208c.

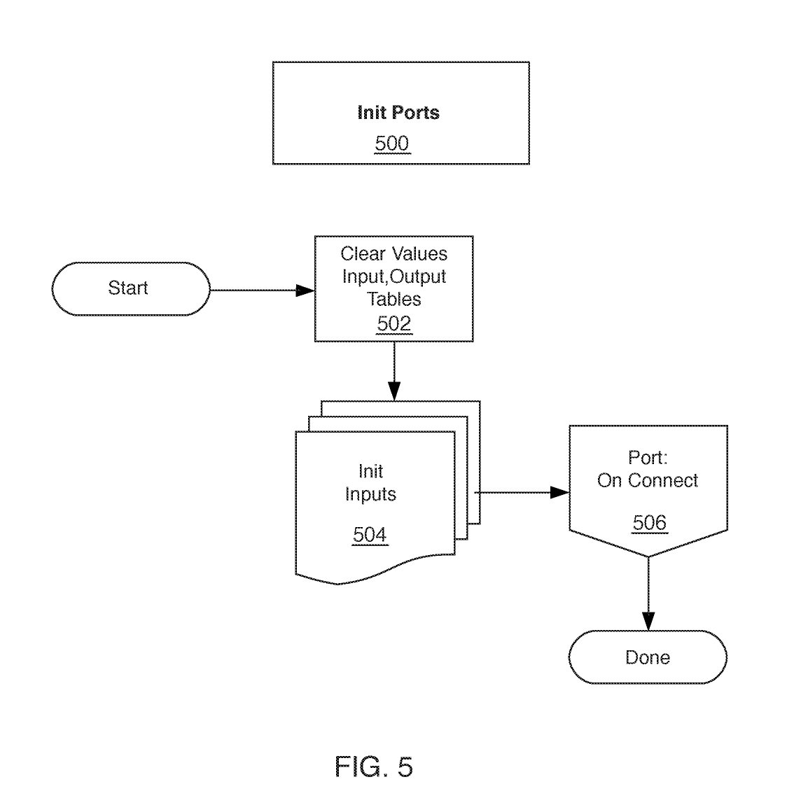

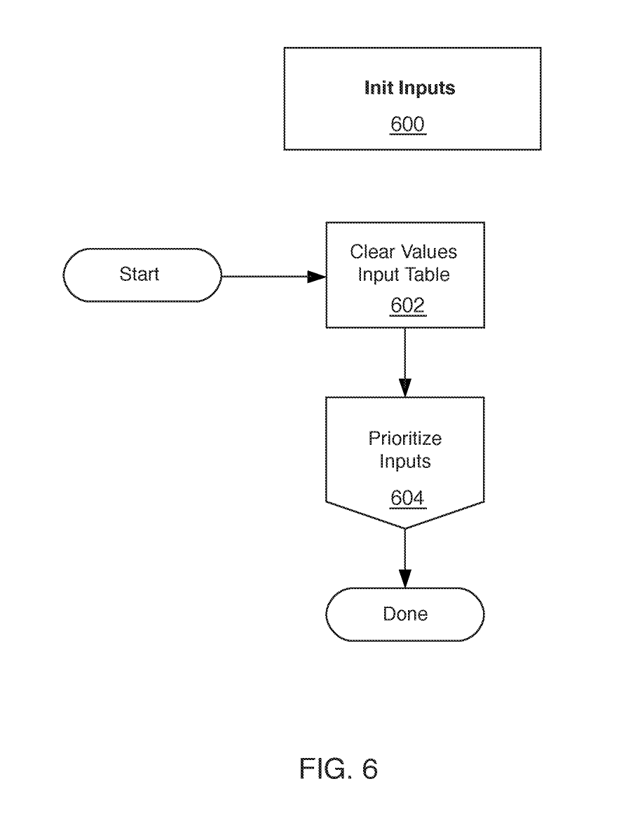

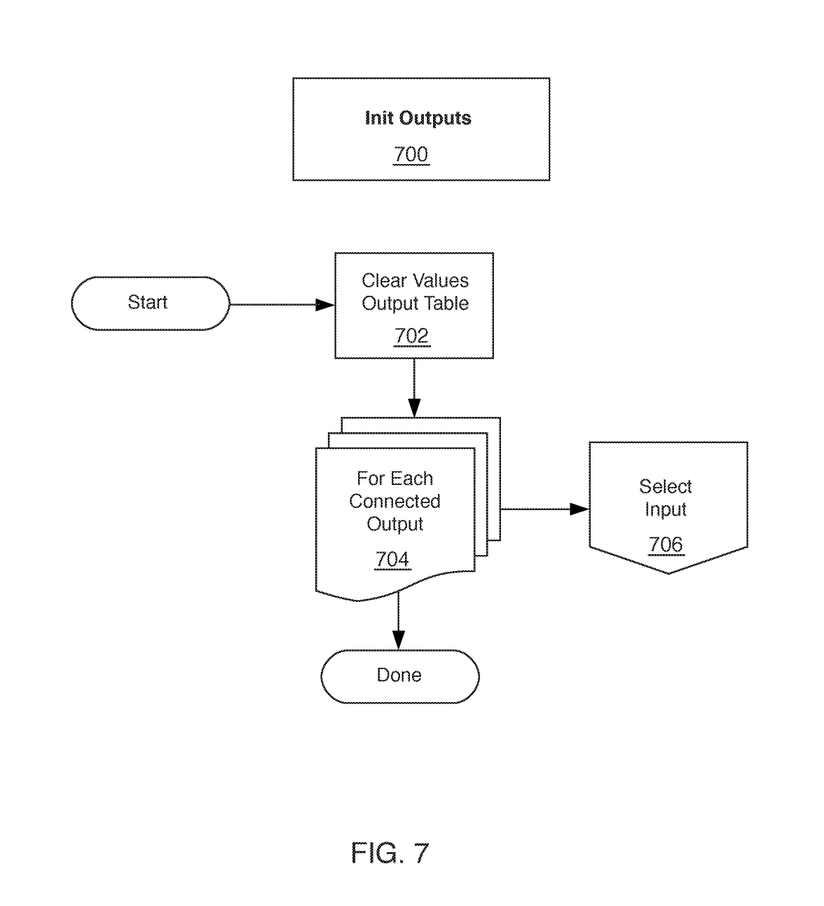

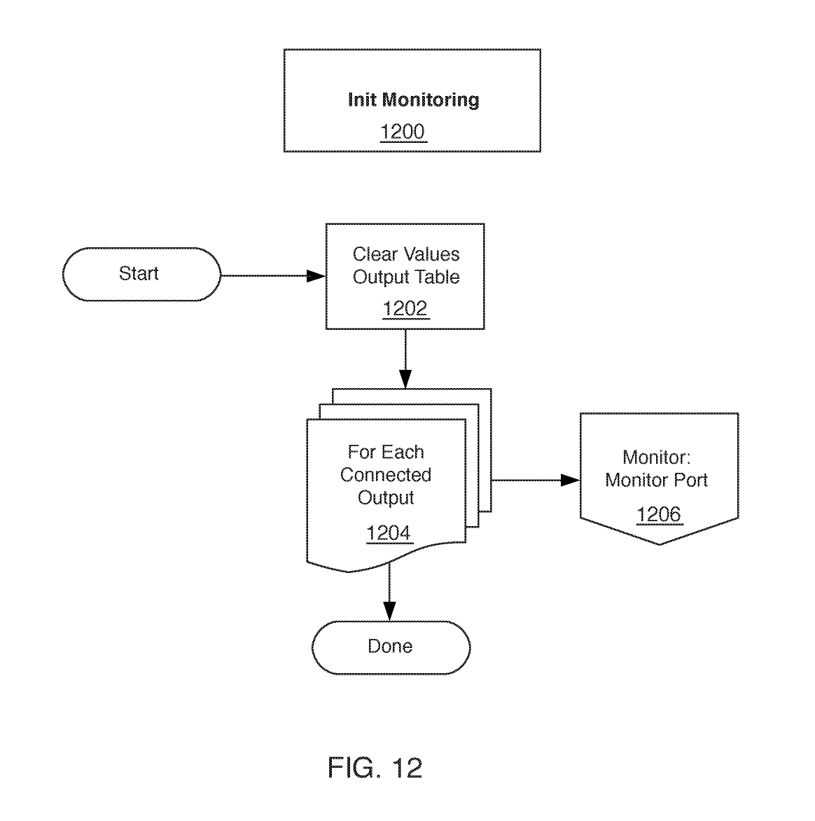

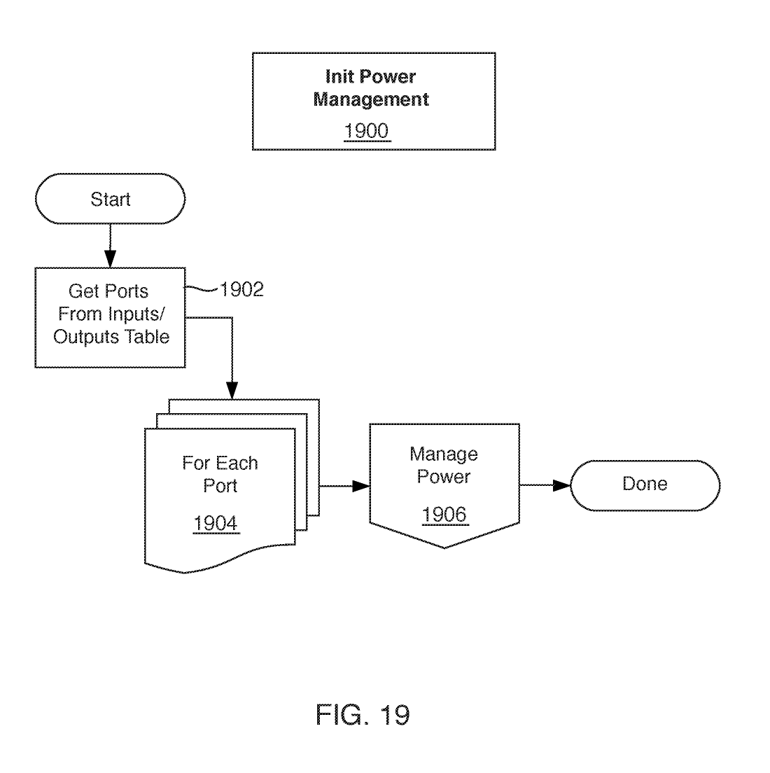

Referring to FIG. 4, the illustrated method 400 may be executed by the controller 200 upon startup thereof, e.g. upon being powered on. The method 400 may include initializing 402 ports (see FIG. 5), initializing 404 inputs (see FIG. 6), initializing 406 monitoring (FIG. 12), initializing 408 outputs (FIG. 7), and initializing 410 power management (FIG. 19).

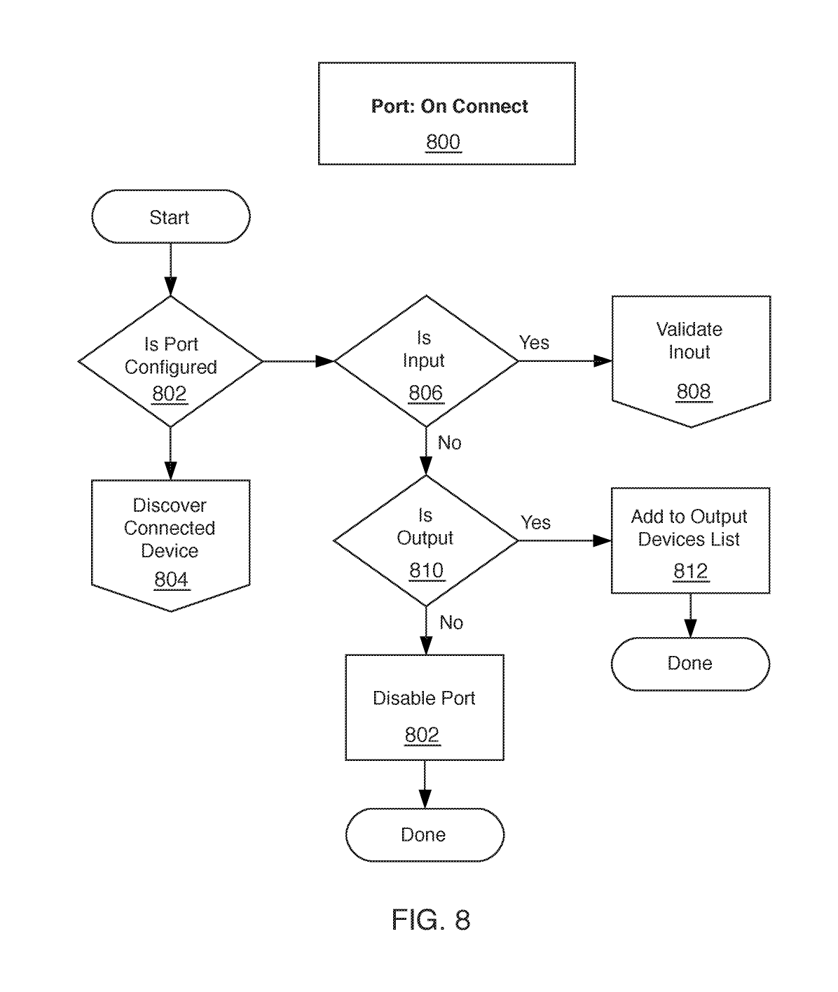

Referring to FIG. 5, the controller 200 may execute the illustrated method 500 to initialize ports. The method 500 may include clearing values from input and output tables (see, e.g. Tables 1 and 2, below) and, looping 504 through each input and, for each input, executing a “On Connect” method of FIG. 8.

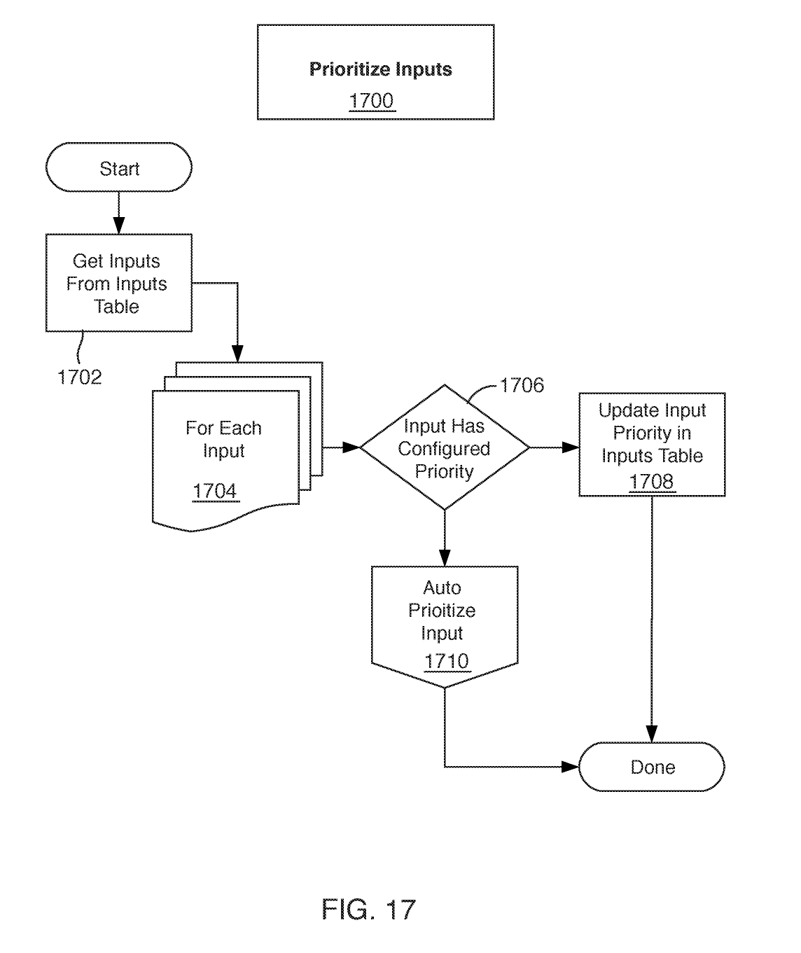

Referring to FIG. 6, the controller 200 may execute the illustrated method 600 upon startup, e.g. powering on, of the controller 200. The method 600 may include clearing 600 values associated with input devices in the port list or device, the port list and device table (see Tables 1 and 2) storing values describing the state of inputs to the controller, e.g. devices coupled to input lines 204a-204c. The input lines 204a-204c may then be evaluated in order to prioritize 604 the input lines according to attributes of the devices coupled thereto. The manner in which the input lines 204a-204c are prioritized is described in detail below with respect to FIG. 17.

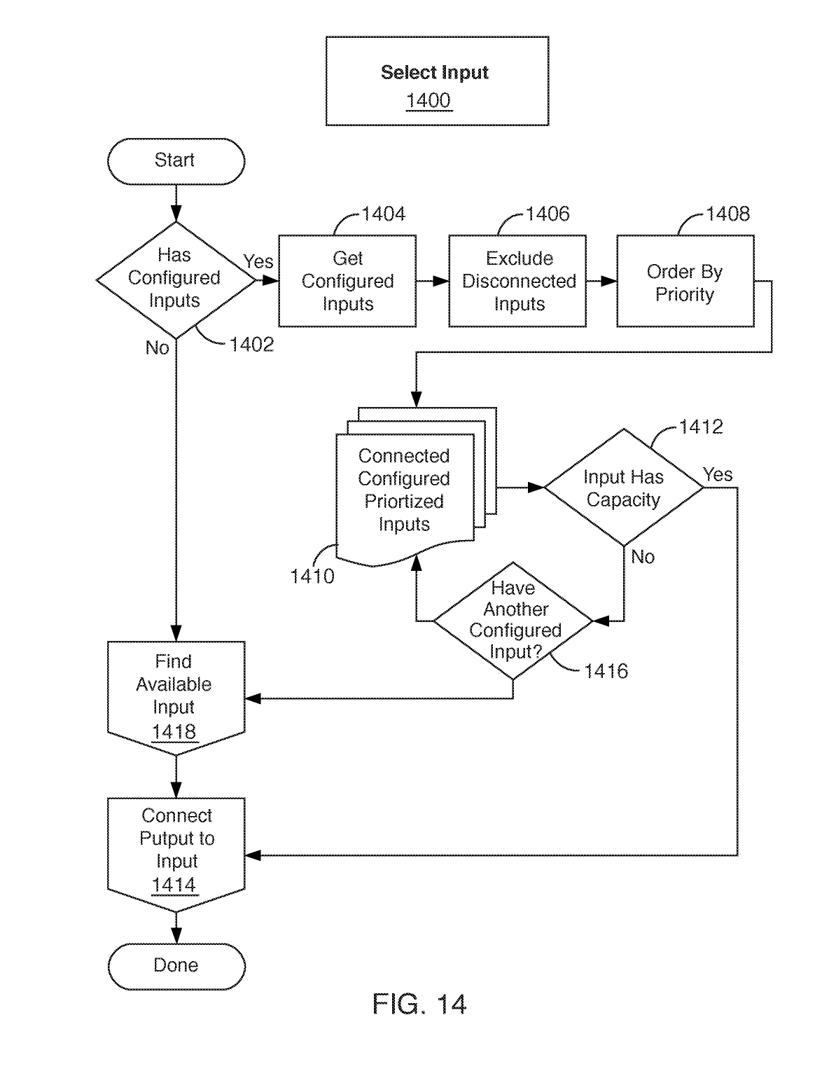

Referring to FIG. 7, the controller 200 may execute the illustrated method 700 upon startup, e.g. powering on, of the controller 200. The method 700 may include clearing 702 values associated with output devices in the port list and the device table, the port list and device table (see Tables 1 and 2) storing values describing the state of output to the controller, e.g. devices coupled to output lines 208a-208c. The output lines 208a-208c may then be evaluated in order to loop 704 through each output line 208a-208c having a device coupled thereto and, for each connected output line 208a-208c, selecting 706 an input line 204a-204c to coupled thereto. The manner in which the input lines 204a-204c are selected 706 for each output line 208a-208c is described in detail below with respect to FIG. 14. The outputs may have priorities assigned thereto and the looping 704 through the outputs may be performed in order of priority. The priority of an output may be manually set, manually set based on a device type coupled to the output, or based on some other criteria. The type of a device coupled to an output may be determined by querying the device for a device or device type identifier or by detecting power usage of the device corresponding to a device of a particular type (e.g. amount of power used).

Referring to FIG. 8, the controller 200 may execute the illustrated method 800 upon detecting connection of a device to a port (e.g. one of the input lines 204a-204c or output lines 208a-208c). The method 800 may include determining 802 whether the port is configured, i.e. whether a record is stored by the controller 200 that describes a device coupled to the port. For example, the controller 200 may manage or access memory storing data listed below in Table 1 for each port.

TABLE 1
Port List

| | | | Device | | Current | Current | Flap | Current | Used |
|---|---|---|---|---|---|---|---|---|---|
| ID | Direction | Connected | ID | Bus | Voltage | Current | Count | Temp. | Power |
| 1 | In | 1 | 101 | 1 | 5 | 450 | 0 | 80 | 500 |
| 2 | In | 1 | 58 | 2 | 4.7 | 0 | 1 | 80 | 25 |
| 3 | Out | 1 | 78 | 1 | 5 | 450 | 0 | 80 | 525 |
| 4 | | 0 | | | | | | | |

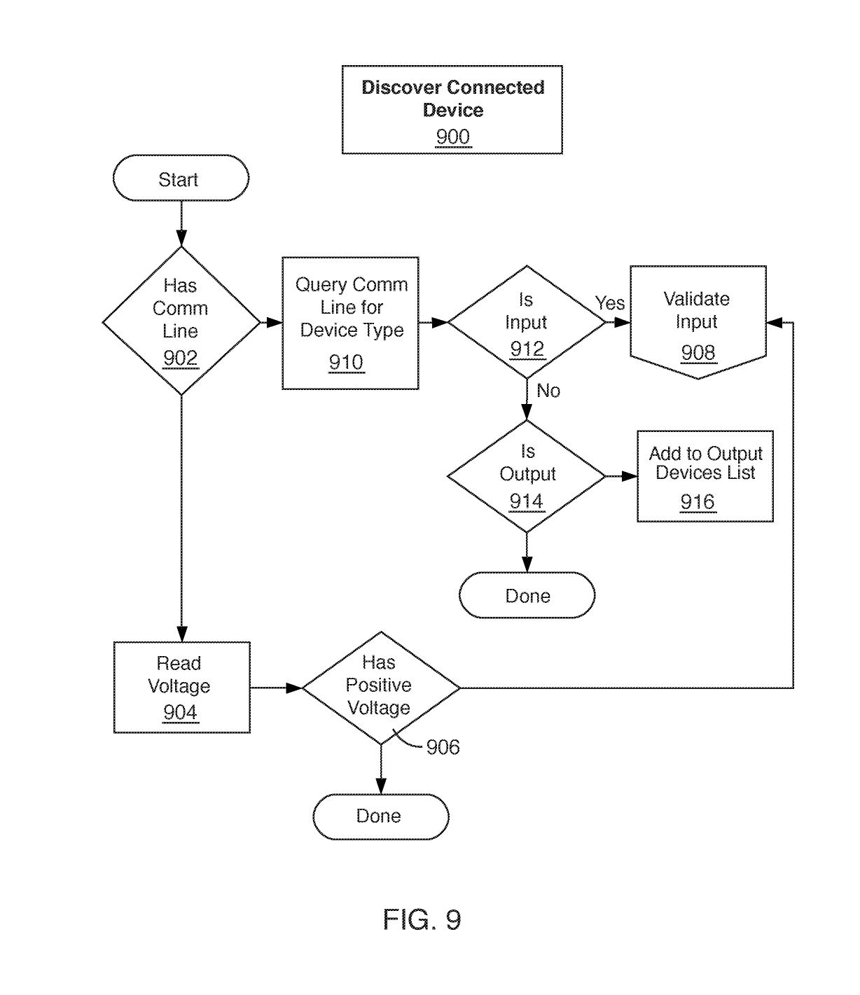

The fields of a port list as shown in Table 1 may include an identifier field (ID) that uniquely identifies each port, e.g. each input line 204a-204c and output line 208a-208c of the control device 102. The “Direction” field may indicate whether the port is an input or output port. The “Device ID” may record a unique identifier of the device previously detected as being connected to the port. The “Device ID” may identify each device or may uniquely identify a class of device. The “Bus” field indicates which of the bus lines 214a-214c to which the port is currently coupled. The “Current Voltage” and “Current Current” fields indicated a most recent measurement of the voltage and current on the port. The “Flap Count” field indicates how many times power from a source connected to an input port has lost power. The “Current Temperature” lists a current temperature measurement of a device coupled to the port. The “Used Power” field indicates how much power has been consumed by a load coupled to an input port or provided by a source coupled to an output port in Coulombs or Amp-hours.

Where the data field for a given port (e.g. an ID in Table 1) indicates that a device is connected (see third column) then the port may be deemed to be configured at step 802. If the port is not deemed to be configured, then the device connected to the port may be discovered 804, such as by executing the method 900 of FIG. 9.

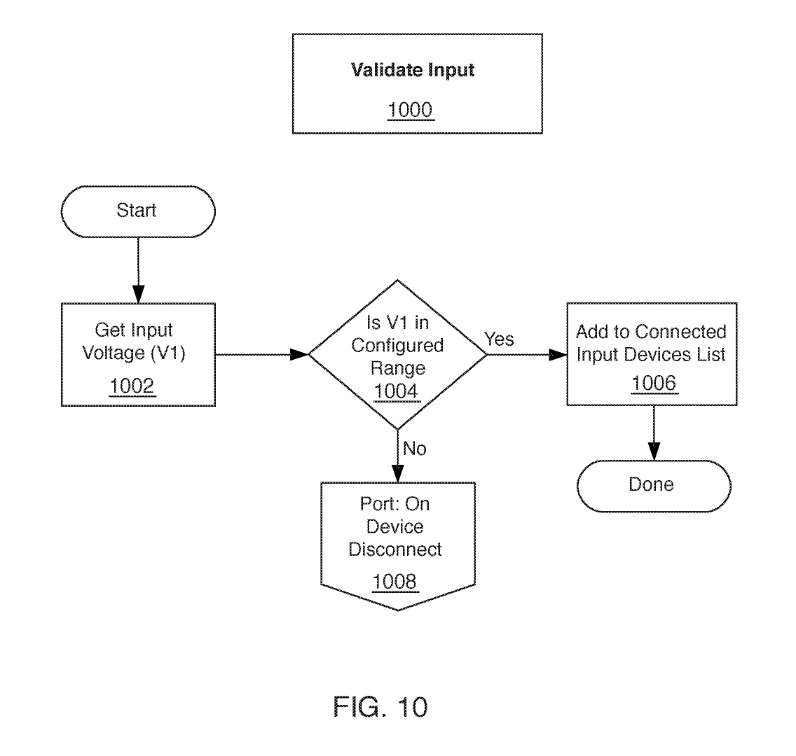

If the port is deemed to be configured, then step 806 may include evaluating whether the port is n input (e.g. whether the “direction” field indicate an input port in Table 1). If it is found 806 to be an input, then the input may be validated 808, which may include executing the method 1000 of FIG. 10.

If the port is not found 806 to be an input, the method 800 may include evaluating 810 whether the port is an output (e.g. whether the “direction” field indicate an output port in Table 1). If it is found 810 to be an output, then the output may be added 812 to a list of output devices. If the port is not found 806, 810 to be either an input or an output, then the port may be disabled 814 and the method 800 may end.

Referring to FIG. 9, the controller 200 may execute the illustrated method 900 as part of the step 804 of discovering a connected device. The method may include evaluating 902 whether the connected device has a communication line, i.e. is capable of performing serialized communication over one or more lines coupling the connected device to the controller 200, which may include communication over an input line 204a-204c or output line 208a-208c. If not, then a voltage on a line (input 204a-204c or output 208a-208c) coupled to the connected device is read 904. If it is not found 906 to be positive, then the method 900 may end. If it is found 906 to be positive, then the connected device may be deemed to be an input device and the input device may be validated 908, such as by performing the method 1000 of FIG. 10.

If the connected device is found 902 to have a communication line, then the controller 200 may query 910 the communication line. If a response to the query is found 912 to indicate that the connected device is an input, then the input is validated 908. If not, the controller 200 may evaluate 914 whether the response to the query indicates that the connected device is an output device. If so, then the connected device is added 916 to an output device list. If not, then the method 900 ends without classifying the connected device as an input or output.

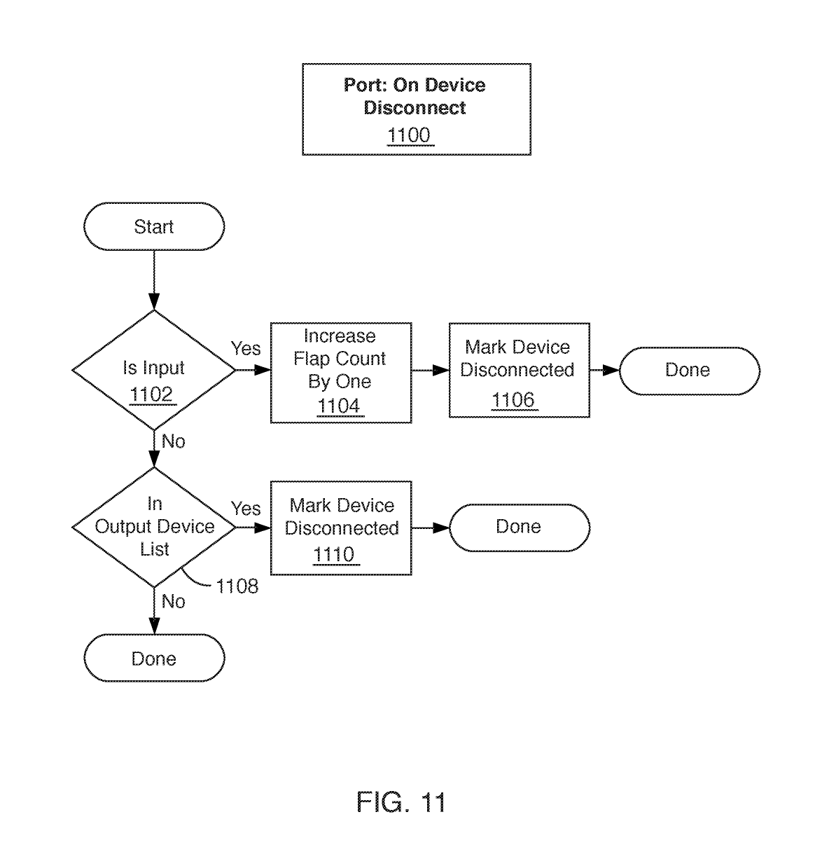

Referring to FIG. 10, the controller 200 may execute the illustrated method 1000 in order to validate an input device, e.g. power source. At step 1002, the input voltage (V1) on the input port coupled to the input device is measured. V1 is then evaluated 1004 with respect to a configured range, i.e. a predetermined range of values deemed allowable for all input devices, a class of input devices to which the input device belongs, or specific to the input device. If V1 is found 1004 to be in the predetermined range, then the input device is added 1006 to a list of connected input devices. If not, then the devices deemed to have been effectively disconnected and the “On Device Disconnect” method of FIG. 11 is executed 1008.

Adding 1006 an output to an output device list and adding an input device to a list of connected device may include creating entries in a data structure including some or all of the fields below for each input or output device. In some embodiments, separate tables may be maintained for input and output devices, i.e. an input device table and output device table.

TABLE 2
Device Table

| | | Default | | Required | Max | Required | Max | |
|---|---|---|---|---|---|---|---|---|
| ID | Description | Priority | Type | Current | Current | Voltage | Voltage | Bus |
| 101 | Charger | 1 | In | 0 | 500 | 3.7 | 5.6 | 1 |
| 58 | Radio | 2 | In | 0 | 200 | 3.7 | 5.6 | 2 |
| 78 | Camera | 1 | Out | 300 | 350 | 3.6 | 5.3 | 1 |

Referring to FIG. 11, the controller 200 may execute the illustrated method 1100 in response to detecting disconnection of a device, such as at step 1004 in the method 1000 or in response to other events that indicate disconnection has occurred. The method 1100 may include evaluating 1102 whether the device is an input or output device, this may include evaluating the “Direction” field in the entry of a data structure corresponding to Table 1 or Table 2 corresponding to the identifier of the device determined to have been disconnected. If the device is found 1102 to be an input device, then the “Flap Count” field for the device is increased 1104 by one and the device is marked 1106 as disconnected, such as by changing the “Connected” field to 0. If the device is not found to be an input device, and is found 1108 to be an output from the “Direction” field, then the devices is marked 1110 as disconnected, such as by changing the “Connected” field to 0 for the entry corresponding to the device.

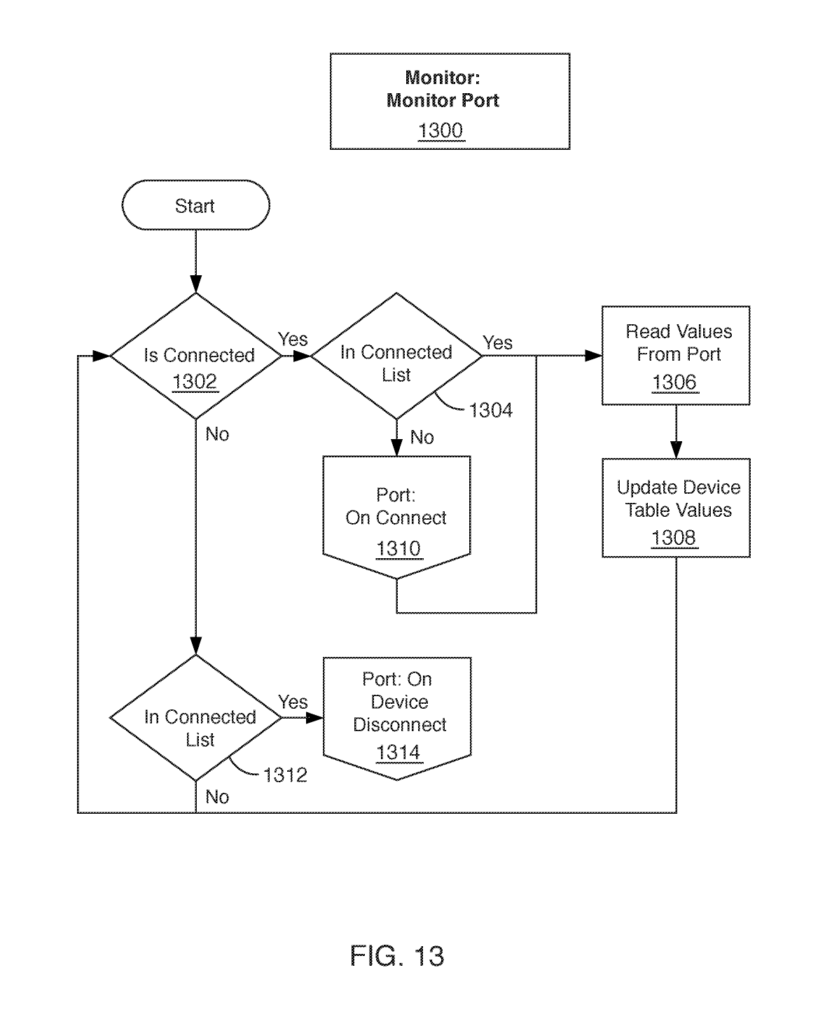

Referring to FIG. 12, the controller 200 may execute the illustrated method 1200 to initiate monitoring of ports, such as in response to being switched on. The method 1200 may include clearing 1202 values in input and output tables, the input and output tables being the input table and output table referenced above with respect to FIGS. 5, 6 and 7. The method 1200 may then include looping 1204 through each port and monitoring 1206 each port. Monitoring 1206 each port may include performing the method 1300 of FIG. 13.

Referring to FIG. 13, the controller 200 may execute the illustrated method 1300 to monitor a port. The method 1300 may be performed for each port. The method 1300 may include evaluating 1302 whether a devices is connected to the port. This may include sensing a non-zero voltage or current on the port. If a device is found 1302 to be connected to the port, then the method 1300 includes evaluating 1304 whether a connected list includes a device as being connected to the port, i.e. the connected input devices list of step 1006 or the output devices list of step 916.

If so, then values are read 1306 from the port and device table values for the device are updated 1308. For example, the current voltage and current current values may be measured and stored in a data structure having the data entries of Table 1, Table 2, or some other data structure. Other values that may be read may include available power (Coulombs or Watt-hours), current temperature, change in temperature, current state of charge (e.g. for a battery), consumed Coulombs (e.g., by a Coulomb counter), input type (power supply, generator, storage device), capacitance, resistance, efficiency, and reliability. If a device is not found in the connected list for the port, then the method 800 of FIG. 8 is executed 1310. If no device is found 1302 to be connected and an entry is found 1312 in the connected list for the port, then the method 1100 of FIG. 11 is executed 1314.

FIG. 14 illustrates a method 1400 that may be executed by the controller 200 to select an input to couple to an output. In particular, the method 1400 may be executed to select 706 an input line 204a-204c to coupled to an output line 208a-208c. The method 1400 may be executed with respect to each output line 208a-208c having a device coupled thereto. The method 1400 may include evaluating 1402 whether there are any configured inputs, i.e. are there any connected devices in the connected input devices list. If so, then the configured inputs are retrieved 1404 from the list, i.e. the input lines 204a-204c that are in the list. Any inputs in the list that are no longer have devices connected may be excluded 1406. The manner in which an input device is detected as no longer being connected may be as described in FIG. 10. The input devices that are connected and configured are then ordered 1408 by priority.

The method 1400 then loops 1410 through the configured and connected inputs in order of priority, and, evaluates 1412 whether the connected and configured input has capacity. Whether an input has capacity may include evaluating a voltage on the input and evaluating usage of the input. For example, if the a power capacity (Watts) of the input device is above is equal to or greater than a required power for the output (e.g. as recorded in the device list of Table 2), then the input may be deemed to have capacity. Otherwise, the input may be deemed to lack capacity. Likewise, if the “Used Power” field (see Table 1) for the input is more than a threshold amount below a capacity of the device connected thereto, then the input may be have capacity. If one or both of these conditions are met, the input may be deemed to lack capacity. In some embodiments, a single input may be coupled to multiple outputs. Accordingly, in such embodiments, determining 1412 whether the input has capacity may include whether a capacity of the input in excess of the power requirements of one or more outputs already coupled to the input is greater than or equal to the requirements of the output.

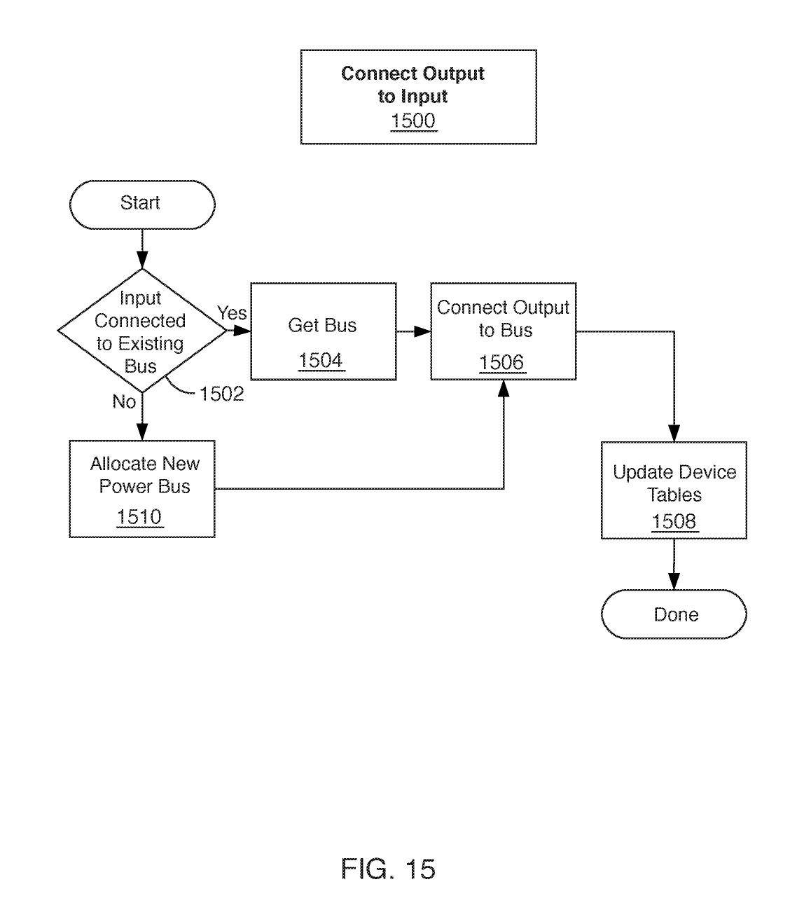

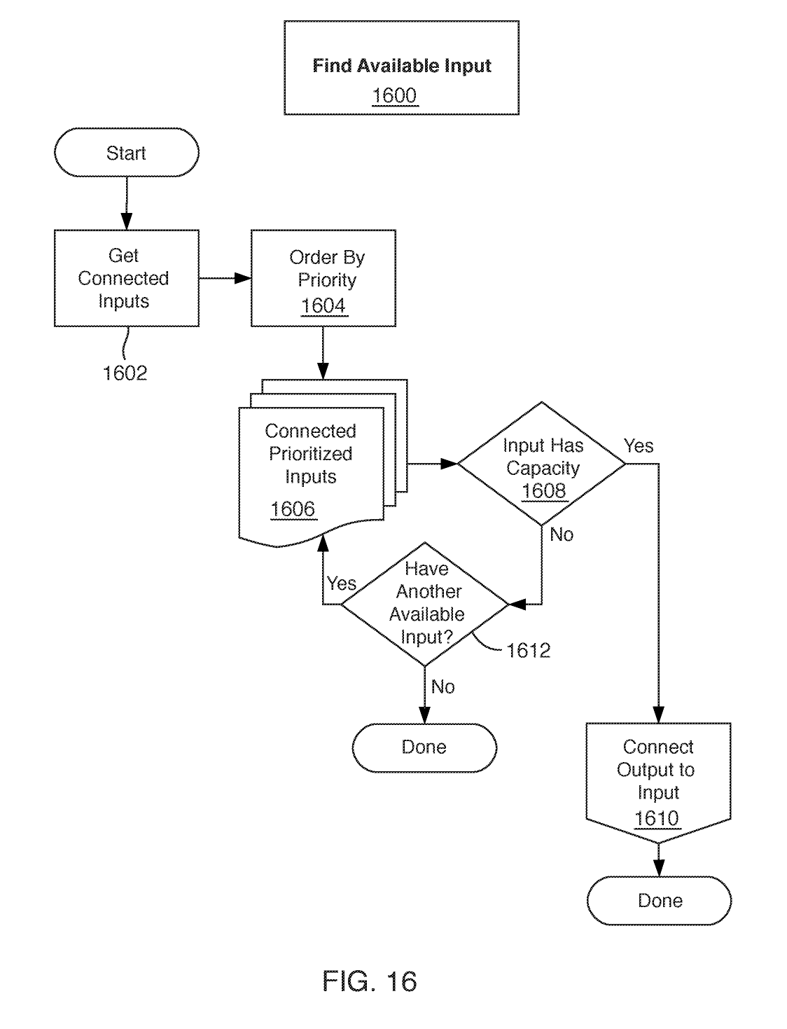

If the input is found 1412 to have capacity, it is connected 1414 to the output port. Connecting the input evaluated at step 1412 to the output may include executing the method 1500 of FIG. 15. If the input is not found 1412 to have capacity, then the method 1400 may include evaluating 1416 whether there is another connected and configured input and, if so, processing continues at step 1412 for that connected and configured input. If there are no more configured and connected inputs, then another available input is found 1418 and the output is connected 1414 to that input. Finding 1418 another available input may include executing the method 1600 of FIG. 16.

FIG. 15 illustrates a method 1500 that may be executed by the controller 200 to connect an input to an output, such as at step 1412. The method 1500 may include evaluating 1502 whether the input is already connected to a bus, e.g. whether the input line 204a-204c to which the input is connected is coupled by the corresponding input MUX 202a-202c to one of the bus lines 214a-24c. If so, then this bus may be retrieved 1504. For example, the port list of Table 1 may list the bus line to which an input is coupled. This value may therefore be retrieved at step 1504. The output is then connected 1506 to this bus line, such as by causing the output MUX 206a-206c to which the output is coupled to connect to the bus line. The device tables may then be updated 1508, for example, an entry may be made in the port list of Table 1 and/or device table of Table 2 indicating that the output is connected to the bus line retrieved at step 1504. If a bus line is not found 1502 to be connected to the input, then a new power bus is allocated 1510 and the output is connected 1506 to that power bus. The new power bus may be a bus line 214a-214c that is not listed in a device table as being coupled to an input.

FIG. 16 illustrates a method 1600 that may be executed by the controller 200 for finding available inputs that at step 1418 of FIG. 14. The method 1600 may include retrieving 1602 connected inputs, such as from the connected input devices list of step 1006. The inputs retrieved at step 1602 are then ordered 1604 according to priority.

The method 1600 may then include looping 1606 through the list of connected input in order of priority. In particular, an input from the list is evaluated 1608 whether it has capacity (see step 1412) and If so, it is connected 1610 to the output (see FIG. 15) and the method ends. If not, then the method 1600 includes evaluating 1612 whether there is another lower priority input in the ordered list. If so, then processing continues at step 1608. If not, the method ends.

Referring to FIG. 17, as is apparent above, the inputs may be prioritized and selected based on priority. The illustrated method 1700 may be used to prioritize inputs. The method 1700 may include obtaining 1702 inputs from the inputs table, e.g. a connected inputs devices list of step 1006. The inputs table may list information for each input, including any priority previously assigned thereto.

The method 1700 may include looping 1704 through each input and executing some or all of steps 1706-1710 for each input. For example, whether the input has a priority already configured may be evaluated at step 1706. For example, this may include evaluating whether an entry for the input in a device table (see, e.g., Table 2) lists a priority or function for determining priority of the input. If so, then the priority of the input is updated 1708 in the device table, such as the input device table (see, e.g., Table 2). For example, the priority may be updated by adjusting the priority down in response to power provided by the input, a rise in temperature of the output, or an increase in the flap count of the input. For example, after a first loss of power (“flap”), the flap count may be incremented to one with no change in priority. If a flap occurs within a predetermined time period (e.g. an hour) of preceding flap, then the priority of the input is halved. The priority may be adjusted up in response to an increase in the capacity (i.e. charging) of the input. In some embodiments, the priority may be specified by a user such that any priority change due to measured values that would otherwise occur is overridden.

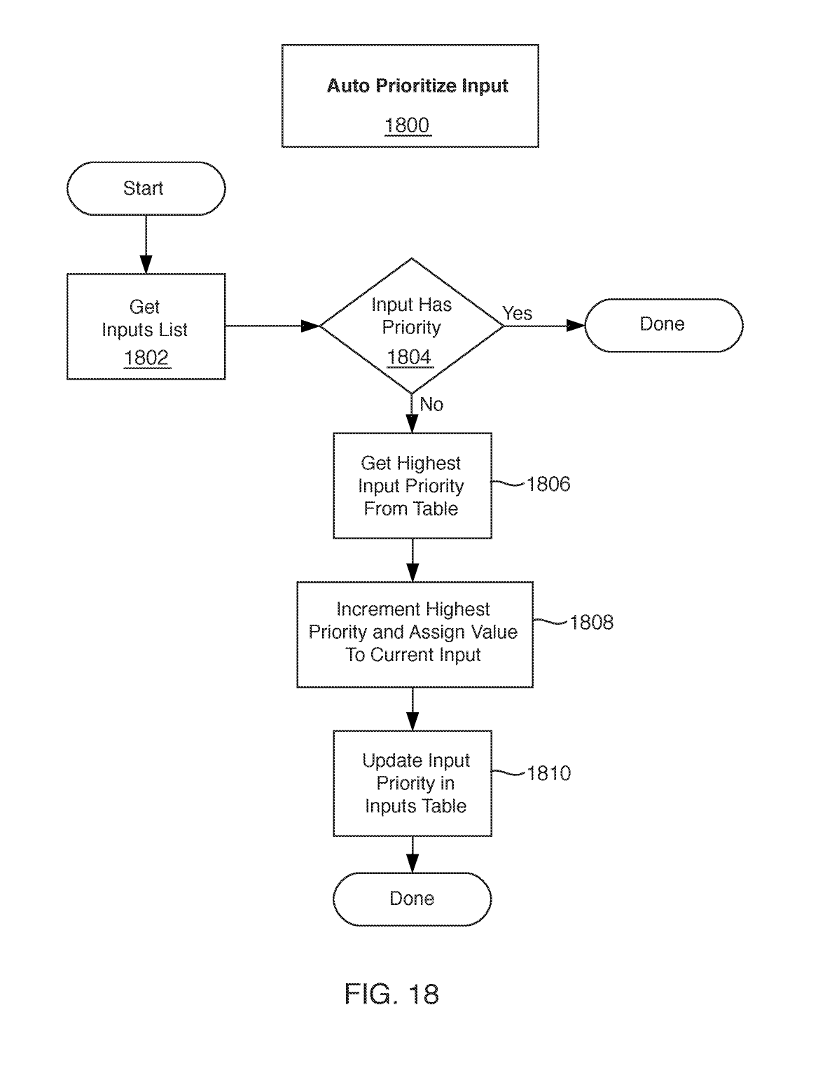

If the priority of the input is not found 1706 to be configured, then the method 1700 may include automatically prioritizing 1710 the input, which may include executing the method 1800 of FIG. 18.

Referring to FIG. 18, the illustrated method 1800 may be executed by the controller 200 to automatically assign a priority to an input (“the current input”). The method 1800 may include obtaining 1802 an input list, such as the connected input devices list. The method may include evaluating 1804 whether the current input has a priority included in the input list. If so, then the method ends. If not, then the highest input priority in the table is retrieved 1806 and incremented 1808. The inputs table is then updated 1810 to include the incremented priority value for the current input.

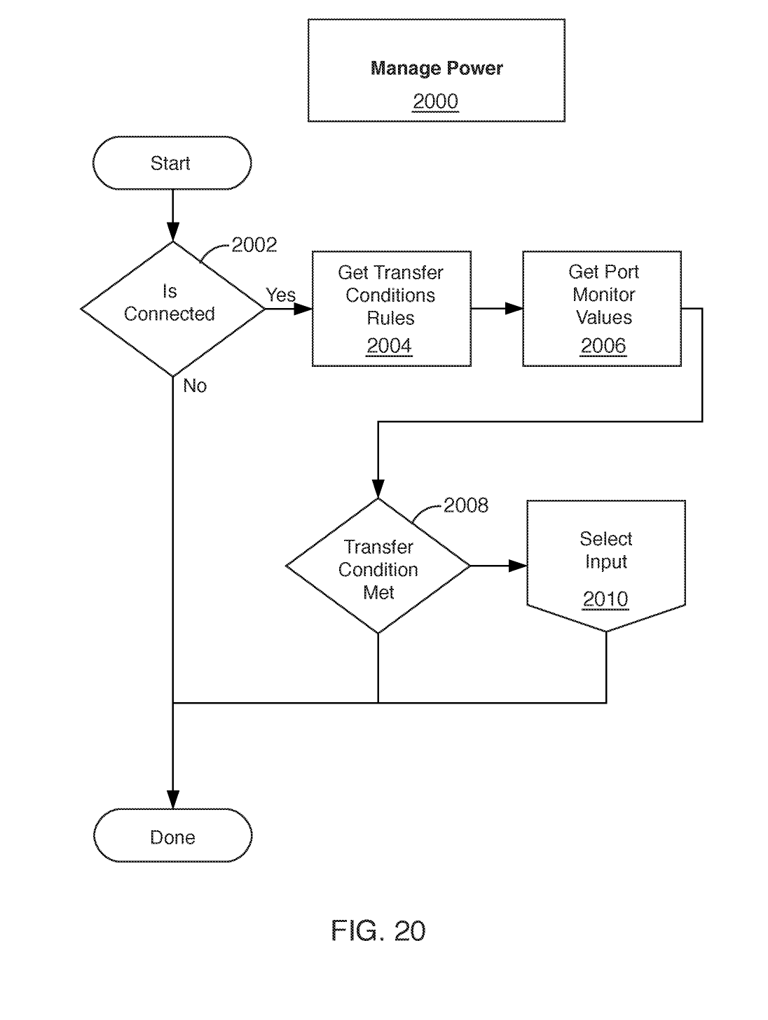

The priority of an input may be determined from or specified in an input priority table (see Table 3, below). For example, Table 3 may have entries including an output identifier and input identifier for a device (e.g. a device having both a load and a source device) and a priority thereof. The input priority rules determine the order in which inputs are used to power outputs. For example, an input with priority 1 is used first, then the input with priority 2, and so forth. If the input with priority 1 has run out of power or reached a transfer condition (i.e. below minimum voltage, power transfer has exceeded maximum threshold, etc.) then the input selection algorithm runs to select a new input based on either the transfer rule or the input priority, as described below with respect to FIG. 20.

TABLE 3
Input Priority Table.

| Output ID | Input ID | Priority |
|---|---|---|
| 78 | 101 | 1 |
| 78 | 58 | 1 |

Referring to FIG. 19, the illustrated method 1900 may be executed by the controller 200 in order to perform power management with respect to devices coupled to the inputs and outputs of the control device 102. The method may include retrieving 1902 a list of ports from an inputs/outputs table. The inputs/outputs table may include some or all of the data listed above in the ports table (Table 1) and the device table (Table 2) and may include either of these tables. The method 1900 may further include looping 1904 through each port and managing 1906 power through each port, where managing 1906 power includes executing the method 2000 of FIG. 20.

Referring to FIG. 20, the illustrated method 2000 may be executed by the controller 200 with respect to each port (“the current port”) of the control device 102. The method 2000 may include evaluating 2002 whether a device is connected to the current port, i.e. whether the “Connected” field of the port list is a “1.” If not, the method 2000 ends with respect to that port. If so, then one or more transfer condition rules are retrieved 2004 and port monitor values are retrieved 2006. The transfer condition rules are pre-defined rules that specify conditions under which an output may be switched to a different input. The port monitor values may be values measured on a port, such as according to the method 1300 of FIG. 13.

If a transfer condition is found 2008 to be met with respect to the current port, then an input is selected 2010 for the current port. Selecting 2010 an input may include executing the method 1400 of FIG. 14 with respect to the current port. The transfer condition for a port may include a range of acceptable values for one or both voltage and current, where the monitored values for the port do not fall within the range of acceptable values, then the transfer condition may be deemed to have been met. If the transfer condition is not found 2008 to be met, then the method 2000 ends without selecting a new input.

The foregoing description describes a power coordination and control device 102 that allows one or more portable devices to share power with each other, to share an auxiliary power source, and to share a single charger. The control device 102 provides some or all of the following benefits: 1) sensing the status of multiple power inputs, 2) making decisions based on logical rules to switch a device from one power source to another, 3) avoiding loss of power during power transfer, 4) reducing the number of batteries, cables, etc. that must be carried and 3) reducing the weight of the portable devices.

Each portable device connected to the control device 102 may receive power from other connected devices or give power to other connected devices. For example a person may carry a cell phone and have a laptop in a backpack. The control device 102 can transfer power from the laptop to the cell phone to charge the phone or to simply supply enough power to operate the phone.

The control device 102 can provide charge power to each connected device from a single power source. For example, control device 102 may be plugged into a wall. It may then charge a phone, tablet, and body-worn camera all at the same time. In another example, a person may stand near a wireless power source and having a device capable of harvesting power from that power source. The control device 102 can take power from the wireless power source to charge all of the devices connected to the control device 102.

The control device 102 may provide operating power to each connected device from a single or multiple auxiliary power sources, such as a battery or power generation device. For example, a phone may have a case that includes a battery for extending the battery life of the phone. The control device 102 may take power from that case and share it with a tablet computer as well.

The functionality of the control device 102 enables the runtime of portable devices to be extended. The control device 102 can apply priority to devices requiring power, thereby providing longer runtime to high priority devices at the expense of lower priority devices. For example, a cell phone and a tablet may be connected to the control device 102. The control device 102 may be configured to keep the cell phone operating at the expense of all other devices. Since the cell phone has higher priority, the control device 102 transfers power from the tablet to the phone when needed, to ensure the phone continues to operate.

The control device 102 may track the power usage of devices (e.g. using monitoring system 218) to learn how much power they typically consume and at what times of day in order to create usage profiles. These usage profiles can be used by the control device 102 to predictively draw power from a device that will not use all of its power to provide power to another device that needs additional power—extending the runtime of the second device. For example, a cell phone and a tablet PC may be coupled to the control device 102. The cell phone may be used much more than the tablet PC. The control device 102 tracks the power usage of these devices and creates a power profile for each device, e.g. track power usage with respect to time by each device. Continuing with this example, a body-worn camera may be connected to the control device 102 and require additional power. The control device 102 transfers power from the tablet and phone, based on the profiles it has created, allowing the body-worn camera to operate beyond its internal battery capacity without interfering with use of the phone.

The control device 102 is capable of transferring the power source for a device (load) from one power supply to a second power supply without disrupting power to the load. For example, if switching batteries is required (e.g., in a two way radio), the power coordination device can temporarily or permanently switch to an alternate power source allowing the device to continue to operate without disruption while the battery is replaced. For example, a police officer may have a portable two-way radio connected to the control device 102. The radio relies primarily on its battery, but the battery runs out periodically and must be changed. The control device 102 will supply power to the radio automatically while the battery is being changed, so that the radio continues to operate—allowing the officer to continue to receive and transmit over the radio during the battery swap.

If switching power sources is desirable, the control device 102 can temporarily or permanently switch to an alternate power source without dropping power to load. For example, the control device 102 may be programmed to give greater priority to a cell phone than to other connected devices. Once the cell phone has no battery remaining, the control device 102 will transfer the cell phone from one power supply to another, as needed, to ensure the cell phone continues to operate, without the phone turning off or rebooting.

In another example, a person may wear a kinetic power generation device coupled to the control device 102. The control device 102 can switch to draw power from the generation device when power is being generated by the power generation device, and switch back to internal battery when the power generation device is not supplying power.

The control device 102 further allows devices that do not have internal power storage to be used in a portable manner. For example, a user may have a video camera that is normally not portable. It may be connected to the control device that provides power to it from a connected tablet computer, allowing it to be used in a portable manner.

The control device 102 allows devices to share one or more power storage devices to increase overall runtime, reduce battery charge cycles, improve efficiency and reduce the weight of carried devices. For example, a single charging power source may be shared among multiple storage devices to reduce the number of chargers required to service portable devices. For example, a person may wear a kinetic power generator and it can be used to charge all devices he or she has in his or her possession without manually plugging or unplugging them.

The control device 102 reduce the number of times charging of devices is required, increasing overall efficiency. By allowing power draw to be taken from sources according to a priority, certain devices may not need to be charged at all at the end of the day. If a power generator is available, its capacity may be redirected to charge devices when it is not otherwise in use. Likewise, the control device may be programmed to select which device to charge and which not to charge, or charge devices according to a priority.

The following use case illustrates how the above-described benefits of the control device. A public safety officer is often required to wear multiple technology devices including: a radio, a body-worn camera, a cell phone, a pager, an audio recording device, etc. In prior approaches, each device must currently be individually charged. And, if any device runs out of power, the officer must interrupt his shift to change the battery, charge the device or swap the device out for a fully charged alternate. In some cases, such as the officer's radio, changing the battery can create a serious safety issue while the officer's radio is offline. Each device the officer wears may include a battery. Some devices may have more battery capacity than is needed to last the officer's entire shift. And, some are not important to the officer's safety. Other devices may run short of battery life before the end of the shift. Some devices may have the capability to charge wirelessly, while others require a hard-wired connection to charge.

The Power Coordination and Control Device (control device 102) allows the officer to consolidate all available power sources among the devices he or she is wearing. The control device 102 may then be programmed to automatically optimize runtime of critical devices—such as the radio—at the expense of less important devices. Or, the control device 102 may simply be used to ensure that certain devices on the officer's person never go offline—such as the radio and the body-worn camera. The control device 102 transfers power from one device to another on an as-needed basis, based on the health and availability of input power, the priority of the devices receiving power, and other factors.

The present invention may be embodied in other specific forms without departing from its purposes, functions, structures, or operational characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. A system comprising:
a plurality of devices collectively including plurality of loads and a plurality of sources at least a portion of the plurality of devices including both of one of the loads of the plurality of loads and one of the sources of the plurality of sources, each source of the plurality of sources storing electrical power and each load of the plurality of loads being an electronic device that consumes electrical power; and
a controller coupled to the plurality of devices, the controller programmed to:
assign a priority to each load of the plurality of loads;
assign a priority to each source of the plurality of sources according to a current state of the each source; and
couple the plurality of loads to the plurality of sources such that each load of the plurality of loads is coupled to a selected source of the plurality of sources, the selected source being selected according to the priority of the each load and the priority of the selected source, wherein each load of the plurality of loads is coupled to a different source of the plurality of sources.

2. The system of claim 1, wherein each device of the plurality of devices includes a separate housing, the housing including a mounting structure for mounting to the clothing of a person.

3. The system of claim 2, wherein the plurality of devices include two or more of a radio, a body-worn camera, a laptop computer, flashlight and a cellphone.

4. The system of claim 3, wherein the plurality of devices include a portable power generator.

5. The system of claim 1, further comprising:
a power bus including a plurality of lines;
a plurality of multiplexers each coupled to one of (a) one of the plurality of loads and (b) one of the plurality of sources, each multiplexer of the plurality of multiplexers having a control input thereof coupled to the controller and being further coupled to the plurality of lines;
wherein the controller is further programmed to couple each load to the selected source thereof by causing the multiplexers of the plurality of multiplexers coupled to the each load and the selected source to select a same line of the plurality of lines.

6. The system of claim 1, wherein the controller is further programmed to:
monitor usage of each source of the plurality of sources;
adjust the priority of each source of the plurality of sources according to the usage; and
decouple at least one load of the plurality of loads from the selected source thereof and coupling the at least one load to a new source of the plurality of sources in response to adjusting of the priority of each source of the plurality of sources.

7. The system of claim 6, wherein the controller is programmed to adjust the priority of each source of the plurality of sources according to the usage by reducing the priority of the each source in response to a reduction in charge remaining in the each source.

8. The system of claim 6, wherein the controller is programmed to reduce the priority of each source of the plurality of sources in response to detecting a rise in temperature of the each source.

9. The system of claim 6, wherein the controller is programmed to reduce the priority of each source of the plurality of sources in response to detecting a temporary loss of power from the each source.

10. The system of claim 1, wherein the controller is further programmed select the selected source according to the priority of the each load and the priority of the selected source by:
order the plurality of sources according to priorities thereof;
assign to the each load an available source from the plurality of sources that has a highest priority of all available sources of the plurality of sources.

11. A method comprising:
providing a plurality of devices collectively including plurality of loads and a plurality of sources at least a portion of the plurality of devices including both of one of the loads of the plurality of loads and one of the sources of the plurality of sources, each source of the plurality of sources storing electrical power and each load of the plurality of loads being an electronic device that consumes electrical power; and
a controller coupled to the plurality of devices, the controller programmed to:
assigning, by a controller, a priority to each load of the plurality of loads, the controller coupled to the plurality of devices;
assigning, by the controller, a priority to each source of the plurality of sources according to a current state of the each source; and
coupling, by the controller, the plurality of loads to the plurality of sources such that each load of the plurality of loads is coupled to a selected source of the plurality of sources, the selected source being selected according to the priority of the each load and the priority of the selected source, wherein each load of the plurality of loads is coupled to a different source of the plurality of sources.

12. The method of claim 11, wherein each device of the plurality of devices includes a separate housing, the housing including a mounting structure for mounting to the clothing of a person.

13. The method of claim 12, wherein the plurality of devices include two or more of a radio, a body-worn camera, a laptop computer, flashlight and a cellphone.

14. The method of claim 13, wherein the plurality of devices include a portable power generator.

15. The method of claim 11, further comprising:
providing, by the controller, a power bus including a plurality of lines;
providing, by the controller, a plurality of multiplexers each coupled to one of (a) one of the plurality of loads and (b) one of the plurality of sources, each multiplexer of the plurality of multiplexers having a control input thereof coupled to the controller and being further coupled to the plurality of lines;
wherein coupling each load to the selected source thereof comprises causing the multiplexers of the plurality of multiplexers coupled to the each load and the selected source to select a same line of the plurality of lines.

16. The method of claim 11, further comprising:
monitoring, by the controller, usage of each source of the plurality of sources;
adjusting, by the controller, the priority of each source of the plurality of sources according to the usage; and
decoupling, by the controller, at least one load of the plurality of loads from the selected source thereof and coupling the at least one load to a new source of the plurality of sources in response to adjusting of the priority of each source of the plurality of sources.

17. The method of claim 16, wherein adjusting the priority of each source of the plurality of sources according to the usage comprises reducing the priority of the each source in response to a reduction in charge remaining in the each source.

18. The method of claim 16, further comprising reducing the priority of each source of the plurality of sources in response to detecting a rise in temperature of the each source.

19. The method of claim 16, further comprising reducing the priority of each source of the plurality of sources in response to detecting a temporary loss of power from the each source.

20. The method of claim 11, further comprising selecting the selected source according to the priority of the each load and the priority of the selected source by:
ordering the plurality of sources according to priorities thereof;
assigning to the each load an available source from the plurality of sources that has a highest priority of all available sources of the plurality of sources.
